(19) United States
(12) Patent Application Publication
(10) Pub. No.: US 2017/0355639 A1
(43) Pub. Date: Dec. 14, 2017

(54) SOLAR-CONTROL OR LOW-EMISSIVITY GLAZING COMPRISING AN UPPER PROTECTIVE LAYER

(71) Applicant: SAINT-GOBAIN GLASS FRANCE, Courbevoie (FR)

(72) Inventors: Alexandre MAILLET, Compiegne (FR); Laura Jane SINGH, Paris (FR)

(73) Assignee: SAINT-GOBAIN GLASS FRANCE, Courbevoie (FR)

(21) Appl. No.: 15/536,350

(22) PCT Filed: Dec. 14, 2015
(86) PCT No.: PCT/FR2015/053473

§ 371 Date: Jun. 15, 2017

(30) Foreign Application Priority Data
Dec. 19, 2014 (FR) 1462871

(51) Int. Cl. C03C 17/36

(52) U.S. Cl. CPC C03C 17/366; C03C 17/3615; C03C 17/3644; C03C 2217/212; C03C 2217/23; C03C 2217/256; C03C 2217/281; C03C 2218/156; C03C 2217/78

(57) ABSTRACT

A material includes a transparent substrate coated with a stack of thin layers including at least one silver-based functional metal layer. The stack includes a dielectric layer based on silicon and/or aluminum nitride located above a silver-based functional metal layer and an upper protective layer based on zirconium titanium oxide located above the dielectric layer based on silicon and/or aluminum nitride and exhibiting a ratio by weight of titanium to zirconium Ti/Zr of between 60/40 and 90/10.

The invention relates to a material and to a process for obtaining a material, such as a glazing, comprising a transparent substrate coated with a stack of thin layers comprising at least one silver-based functional metal layer.

Materials comprising silver-based functional metal layers (or silver layers) are used in “solar control” glazings targeted at reducing the amount of solar energy entering and/or in “low-e” glazings targeted at reducing the amount of energy dissipated toward the outside of a building or of a vehicle due to their advantageous properties of electrical conduction and of reflection of infrared (IR) radiation.

The chemical resistance and mechanical strength of the stacks comprising these silver-based functional metal layers is often insufficient. This low resistance/strength is reflected by the appearance in the short term of defects, such as sites of corrosion, scratches, indeed even the complete or partial tearing of the stack during its use under standard conditions. All defects or scratches, whether due to corrosion or mechanical stresses, are liable to detrimentally affect not only the attractiveness of the coated substrate but also its optical and energy performance levels.

These coated substrates are not in general sufficiently resistant/strong to be used in applications where the stack is directly in contact with an uncontrolled environment, such as ambient air in the case of single glazings.

On the other hand, these substrates can be used in the form of double or triple multiple glazings. The stack is then positioned inside the multiple glazing, in contact with a sealed environment consisting of the gas of the intercalated strip. The stack is thus protected from moisture and dust.

In order to improve even more the mechanical strength and chemical resistance in a multiple glazing configuration, the substrate coated with the stack can be marginated. This consists in suppressing, at the periphery of the substrate, over a region of at least 1 mm in width, one or more thin layers in order for the latter not to reach the edges of the substrate and thus prevent the phenomena of corrosion.

The restriction of the use of these materials to multiple glazings, combined with the need to marginate the coated substrates, remain major disadvantages which reduced the advantage of these materials.

In addition, even in the case of use in a multiple glazing, the coated substrates undergo, before assembling, various transformation stages, such as stages of cutting, washing, shaping the edges and/or high-temperature heat treatments of tempering, annealing and/or bending type. It is common and practical to carry out the assembling and/or the various treatments on a site other than that where the substrate coated with the stack is manufactured. These substrates thus also undergo stages of storage and transportation under variable climatic conditions.

The substrates coated with the stacks are subjected, during these different stages, to mechanical and chemical stresses resulting from very different conditions defined in particular by the temperature, the humidity and the nature of the entities constituting the medium in contact with the stack.

The main factors liable to damage the stacks during a high-temperature heat treatment are different from the factors involved during the normal use of the substrate for its dedicated application or during storage. During a high-temperature treatment, these factors are the temperature, generally greater than 400° C., the pressure and the nature of the chemical entities liable to be in contact with the stack. During normal use or during storage, these factors are the duration of storage or lifetime desired, the characteristics of the medium in contact with the stack, such as the humidity, the temperature, generally less than 100° C., and the possible presence of dust.

Upper protective layers are conventionally used for various purposes, in particular in order to improve the scratch resistance or to protect the stack during high-temperature heat treatments. However, the protection provided by the known upper protective layers is generally insufficient:
to make possible use of the material without the appearance of defects or of scratches and/or modification of the optical and energy performance levels for a sufficient period of time, in particular of greater than 12 months before tempering and 30 days after tempering,
to guarantee an unvarying quality of the material independently of the storage conditions, such as the temperature, the humidity and the duration.

The patent EP 0 937 013 B1 discloses substrates coated with stacks intended to undergo a high-temperature treatment of tempering or annealing type conventionally comprising:
dielectric layers based on silicon nitride which are located above a silver-based functional metal layer, the role of which is to protect the underlying layers from oxidation,
upper protective layers which are located above the silicon nitride layers in order to prevent them being damaged by chemical attack by aggressive entities at high temperatures, such as alkaline compounds.

These upper protective layers are deposited in the form of a metal or of a metal oxide chosen from at least one of the following metals: Nb, Sn, Ta, Ti or Zr, or of the following oxides: niobium oxide, tin oxide, tantalum oxide, titanium oxide or zirconium oxide. According to the patent EP 0 937 013 B1, these metals, very particularly niobium, tin and titanium, have in common the formation, by becoming oxidized, of a compound with sodium, so as to limit its diffusion into the underlying layers.

The layers based on titanium oxide make it possible to obtain effective protection of the stack following a high-temperature heat treatment, and also good mechanical strength. However, the substrates coated with such protective layers are subject to corrosion under cold conditions in a humid environment when a stack is not confined in a double glazing and during the various stages of storage and/or transformation.

There exists a need to more effectively protect substrates coated with stacks comprising silver-based functional layers during the manufacturing, transformation, transportation and/or storage stages. More particularly, there exists a need to develop novel stacks which are resistant both to high-temperature heat treatments and also to corrosion under cold conditions. The objective of the invention is in particular to develop materials based on silver-based functional layers which can be used:
independently of the conditions of storage of the material, such as the duration, the temperature and the humidity, and/or
in single glazing or in double glazing without the need to be marginated.

The applicant has discovered, surprisingly, that the use as upper protective layer of a layer of zirconium titanium oxide exhibiting a specific ratio by weight of titanium to zirconium makes it possible to achieve these objectives by considerably improving the resistance to corrosion under cold conditions while retaining a good resistance to the high-temperature heat treatment and a good mechanical strength.

The invention relates to a material comprising a transparent substrate coated with a stack of thin layers comprising at least one silver-based functional metal layer, characterized in that the stack comprises:
a dielectric layer based on silicon and/or aluminum nitride located above a silver-based functional metal layer,
an upper protective layer based on zirconium titanium oxide located above the dielectric layer based on silicon and/or aluminum nitride and exhibiting a ratio by weight of titanium to zirconium Ti/Zr of between 60/40 and 90/10.

The upper protective layer based on zirconium titanium oxide exhibits, in increasing order of preference, a ratio by weight of titanium to zirconium Ti/Zr of between 60/40 and 90/10, between 60/40 and 80/20, between 60/40 and 70/30, between 60/40 and 65/35 or between 60/40 and 64/36.

The upper protective layer based on zirconium titanium oxide exhibits, in increasing order of preference, an atomic ratio of titanium to zirconium Ti/Zr of between 70/30 and 95/5, between 70/30 and 85/15, or between 70/30 and 80/20.

The layers of zirconium titanium oxide can be deposited from a TiZrOₓ ceramic target. The ratio of titanium to zirconium Ti/Zr in the layer is virtually equivalent to that of the target.

The ceramic targets can optionally comprise other elements which are encountered in the layers deposited from these targets.

The upper protective layer is preferably the final layer of the stack, that is to say the layer furthest from the substrate coated with the stack.

The upper protective layer has a thickness:
of less than or equal to 10 nm, of less than or equal to 7 nm or of less than or equal to 5 nm, and/or
of greater than or equal to 1 nm, of greater than or equal to 2 nm or of greater than or equal to 3 nm.

The dielectric layer based on silicon and/or aluminum nitride is preferably in contact with the upper protective layer based on zirconium titanium oxide. The dielectric layer based on silicon and/or aluminum nitride has a thickness:
of less than or equal to 100 nm, of less than or equal to 50 nm or of less than or equal to 40 nm, and/or
of greater than or equal to 15 nm, of greater than or equal to 20 nm or of greater than or equal to 25 nm.

The silver layers are deposited between dielectric coatings which generally comprise several dielectric layers making it possible to adjust the optical properties of the stack. In addition, these dielectric layers make it possible to protect the silver layer from chemical or mechanical attacks. The stack of thin layers thus advantageously comprises at least one silver-based functional metal layer and at least two dielectric coatings, each dielectric coating comprising at least one dielectric layer, so that each functional metal layer is positioned between two dielectric coatings.

Preferably, the stack of thin layers comprises just one functional layer.

The stack of thin layers comprises one or more layers of oxides. However, according to an advantageous embodiment, the total thickness of all the layers of oxides present in the stack is less than 10 nm, preferably less than 5 nm. A stack according to the invention exhibiting this characteristic exhibits the best results in terms of:
resistance to humidity and to storage, reflecting this by an absence of defects and of variations in electrical and colorimetric properties, and/or
mechanical strength, and/or
resistance to a long-lasting heat treatment.

The stack is deposited by cathode sputtering, in particular assisted by a magnetic field (magnetron process). According to this advantageous embodiment, all the layers of the stack are deposited by magnetic-field-assisted cathode sputtering.

Unless otherwise mentioned, the thicknesses referred to in the present document are physical thicknesses. Thin layer is understood to mean a layer exhibiting a thickness of between 0.1 nm and 100 micrometers.

Throughout the description, the substrate according to the invention is regarded as positioned horizontally. The stack of thin layers is deposited above the substrate.

The meaning of the expressions “above” and “below” and “lower” and “upper” is to be considered with respect to this orientation. Unless specifically stipulated, the expressions “above” and “below” do not necessarily mean that two layers and/or coatings are positioned in contact with one another. When it is specified that a layer is deposited “in contact” with another layer or with a coating, this means that there cannot be one or more layers inserted between these two layers.

The silver-based functional metal layer comprises at least 95.0%, preferably at least 96.5% and better still at least 98.0% by weight of silver with respect to the weight of the functional layer. Preferably, the silver-based functional metal layer comprises less than 1.0% by weight of metals other than silver with respect to the weight of the silver-based functional metal layer.

The thickness of the silver-based functional layers is, in increasing order of preference, of from 5 to 20 nm, from 8 to 15 nm.

The stack can comprise at least one blocking layer, the function of which is to protect the silver layers by preventing possible damage related to the deposition of a dielectric coating or related to a heat treatment. These blocking layers are preferably located in contact with the silver-based functional metal layers.

The stack can comprise at least one blocking layer located below and in contact with a silver-based functional metal layer and/or at least one blocking layer located above and in contact with a silver-based functional metal layer.

Mention may be made, among the blocking layers conventionally used, of the blocking layers based on a metal chosen from niobium Nb, tantalum Ta, titanium Ti, chromium Cr or nickel Ni or based on an alloy obtained from at least two of these metals, in particular on an alloy of nickel and chromium (NiCr). The thickness of each blocking overlayer or underlayer is preferably:
at least 0.3 nm or at least 0.8 nm and/or
at most 5.0 nm or at most 2.0 nm.

The dielectric coatings exhibit a thickness of greater than 15 nm, preferably of between 15 and 50 nm and better still of 30 to 40 nm.

The dielectric layers of the dielectric coatings exhibit the following characteristics, alone or in combination:
they are deposited by magnetic-field-assisted cathode sputtering,
they are chosen from dielectric layers having a barrier function,
they are chosen from dielectric layers having a stabilizing function,
they are chosen from oxides or nitrides of one or more elements chosen from titanium, silicon, aluminum, tin and zinc,
they have a thickness of greater than 5 nm, preferably greater than 15nm, of between 15 and 50 nm and better still from 30 to 40 nm.

Dielectric layers having a barrier function is understood to mean a layer made of a material capable of forming a barrier to the diffusion of oxygen and water at high temperature, originating from the ambient atmosphere or from the transparent substrate, toward the functional layer. The dielectric layers having a barrier function can be based on silicon and/or aluminum compounds chosen from oxides, such as SiO₂, nitrides, such as silicon nitride Si₃N₄ and aluminum nitride AlN, and oxynitrides SiOₓN_{y}, optionally doped using at least one other element. The dielectric layers having a barrier function can also be based on zinc tin oxide.

Dielectric layers having a stabilizing function is understood to mean a layer made of a material capable of stabilizing the interface between the functional layer and this layer. The dielectric layers having a stabilizing function are preferably based on crystalline oxide, in particular based on zinc oxide, optionally doped using at least one other element, such as aluminum. The dielectric layer or layers having a stabilizing function are preferably layers of zinc oxide.

The dielectric layer or layers having a stabilizing function can be found above and/or below at least one silver-based functional metal layer or each silver-based functional metal layer, either directly in contact with it or separated by a blocking layer.

According to one embodiment, the stack comprises:
a dielectric coating located below the silver-based functional metal layer,
optionally a blocking layer,
a silver-based functional metal layer,
optionally a blocking layer,
a dielectric layer located above the silver-based functional metal layer,
an upper protective layer.

According to one embodiment, the stack comprises:
a dielectric coating located below the silver-based functional metal layer comprising at least one dielectric layer based on silicon and/or aluminum nitride,
optionally a blocking layer,
a silver-based functional metal layer,
optionally a blocking layer,
a dielectric coating located above the silver-based functional metal layer comprising at least one dielectric layer based on silicon and/or aluminum nitride,
an upper protective layer.

The transparent substrates according to the invention are preferably made of a rigid inorganic material, such as made of glass, in particular soda-lime-silica glass. The thickness of the substrate generally varies between 0.5 mm and 19 mm. The thickness of the substrate is preferably less than or equal to 6 mm, indeed even 4 mm.

The material, that is to say the transparent substrate coated with the stack, may be intended to undergo a high-temperature heat treatment chosen from an annealing, for example a flash annealing, such as a laser or flame annealing, a tempering and/or a bending. The temperature of the heat treatment is greater than 400° C., preferably greater than 450° C. and better still greater than 500° C. The substrate coated with the stack can thus be bent and/or tempered.

The material can be in the form of a monolithic glazing, a laminated glazing or a multiple glazing, in particular a double glazing or a triple glazing.

The material of the invention is suitable in all applications requiring the use of a stack comprising silver layers for which the resistance to the heat treatment and to corrosion under cold conditions are key parameters, such as low-e glazings for the construction industry or glazings for refrigerator doors.

The invention also relates to a process for obtaining a material comprising a transparent substrate coated with a stack of thin layers deposited by cathode sputtering, optionally assisted by magnetic field; the process comprises the sequence of following stages:
at least one silver-based functional metal layer is deposited on the transparent substrate, then
at least one dielectric layer based on silicon and/or aluminum nitride is deposited above the silver-based functional metal layer,
an upper protective layer based on zirconium titanium oxide, exhibiting a ratio by weight of titanium to zirconium Ti/Zr of between 60/40 and 90/10, is deposited above the dielectric layer based on silicon and/or aluminum nitride.

The process can additionally comprise the stage during which the substrate coated with the stack of thin layers is subjected to a heat treatment at a temperature of greater than 400° C., preferably 500° C.

### EXAMPLES

Stacks of thin layers defined below are deposited on substrates made of clear soda-lime glass with a thickness of 4 mm.

For these examples, the conditions for deposition of the layers deposited by sputtering (“magnetron cathode” sputtering) are summarized in table 1 below.

The layers of zirconium titanium oxide are deposited from a TiZrOₓ ceramic target. The ratio of titanium to zirconium Ti/Zr in the target is 64:36 by weight, corresponding to 77:23 by atoms. The ratio of titanium to zirconium Ti/Zr in the layer is virtually equivalent to that of the target.

TABLE 1

| | Targets | Deposition | | |
|---|---|---|---|---|
| | employed | pressure | Gases | Index* |
| Si₃N₄ | Si:Al (92:8% | 2-15*10⁻³ mbar | Ar: 30-60% - | 2.00 |
| under Ag | by weight) | | N₂: 40-70% | |
| Si₃N₄ | Si:Al (92:8% | 2-15*10⁻³ mbar | Ar: 30-60% - | 2.06 |
| over Ag | by weight) | | N₂: 40-70% | |
| NiCr | Ni:Cr (80:20% | 1-5*10⁻³ mbar | Ar at 100% | — |
| | at.) | | | |
| Ag | Ag | 2-3*10⁻³ mbar | Ar at 100% | — |
| TiO₂ | TiOₓ | 1.5*10⁻³ mbar | Ar 88% - | 2.32 |
| | | | O₂ 12% | |
| TiZrO | TiZrOₓ | 2-4*10⁻³ mbar | Ar 90% - | 2.32 |
| | | | O₂ 10% | |

at.: by atoms;
*at 550 nm

The materials and the physical thicknesses in nanometers (unless otherwise indicated) of each layer or coating of which the stacks are composed are listed in the table below as a function of their positions with regard to the substrate carrying the stack.

The substrates coated with stacks protected according to the invention can be tempered or bent and do not need to be marginated when they are fitted as a double glazing.

| Glazing | | Comparative | Invention |
|---|---|---|---|
| Upper protective layer | TiZrOₓ | — | 3 |
| | TiOₓ | 3 | — |
| Dielectric coating | Si₃N₄ | 35 | 35 |
| Blocking layer BO | NiCr | 0.4 | 0.4 |
| Functional layer | Ag | 7 | 7 |
| Blocking layer BU | NiCr | 0.7 | 0.7 |
| Dielectric coating | Si₃N₄ | 35 | 35 |
| Substrate (mm) | glass | 4 | 4 |

### I. Resistance to the High Humidity Test and the Cleveland Test

In order to show the improvement in the lifetime of the stack, a High Humidity (HH) test and a Cleveland (CV) test are carried out.

The high humidity (HH) test consists in storing samples at 95% relative humidity and at 40° C. and observing the possible presence of defects, such as corrosion pits.

The Cleveland test consists of subjecting the coated substrate to the following cycle:
rise in temperature from 23° C. to 56° C. in 45 min,
maintenance at 56° C. and 95% humidity for 2 hours,
fall from 56° C. to -15° C. in 1h 30,
maintenance at -15° C. for 1 hour,
rise in temperature from -15° C. to 23° C. in 45 min.

The following assessment indicators were used to record the possible detrimental changes:
“+”: no defect,
“0”: a few sites of corrosion,
“−”: presence of defects.

| Test | | Comparison | Invention |
|---|---|---|---|
| HH | 7 days | − | + |
| | 56 days | − | 0 |
| CV | 28-56 days | − | + |
| | 56 days | − | + |

The materials comprising the protective layer according to the invention withstand the two tests for at least 56 days, whereas the comparative material exhibits defects from 7 days in the HH test and from 26 days in the CV test. The solution of the invention makes it possible to significantly improve the lifetime of the material, in particular by a factor of 2 or 8 according to the HH or CV test.

### II. Variations in Electrical and Colorimetric Properties

The colorimetric variations (AE) and the sheet resistance variations (ARsq) were evaluated:
AE represents the variation between the L*, a* and b* values obtained for a coated substrate before and after having been subjected to an HH or CV test. The L*, a* and b* values corresponding to the colors in reflection, on the side of the layers, in the LAB system, measured according to the D65 illuminant, are measured before and after the tests. The variation is calculated in the following way: ΔE=(Δa*²+Δb*²+ΔL*²)^{1/2}.
ΔRsq corresponds to the variation between the sheet resistance values obtained for a coated substrate before and after having been subjected to an HH or CV test. The sheet resistance (Rsq), corresponding to the resistance of a sample with a width equal to the length (for example 1 meter) and of any thickness, is measured with a Nagy device.

| Test | | | Comparison | Invention |
|---|---|---|---|---|
| HH | ΔE | 56 days | 2.1 | 1.4 |
| | ΔRsq | 56 days | 0.3 | 0.2 |
| CV | ΔE | 56 days | 1.7 | 0.9 |
| | ΔRsq | 56 days | 0.6 | 0.4 |

Ill. Evaluation of the Mechanical Strength

In order to evaluate the mechanical strength of the stack, different tests were carried out on the material according to the invention:
Erichsen Brush Test (EBT), before and after tempering, at 1000 cycles,
Opel test at 2000 cycles,
Cleaning test.

The Erichsen brush test (EBT) consists in subjecting different coated substrates, before tempering (EBT) and after tempering (HT-EBT), to a certain number of cycles (1000) during which the stack, covered with water, is rubbed using a brush. It is considered that a substrate satisfies the test if no mark is visible to the naked eye. The test before tempering gives a good indication with regard to the ability of the glazing to be scratched during a washing operation. The test after tempering gives a good indication with regard to the propagation of the scratches after heat treatment.

The Opel test makes it possible to evaluate the abrasion resistance. It is carried out in accordance with the standard EN1096-2 at 2000 cycles.

The cleaning test consists of three passes of the substrate through a washing machine.

The material according to the invention satisfies each of its tests.

### IV. Evaluation of the Resistance Subsequent to a Long-Lasting Heat Treatment

In order to evaluate the resistance to long heat treatments, the material according to the invention protected by an upper protective layer made of TiZrOₓ was heated at 400° C. for 500 h. No deterioration is observed.

The main optical characteristics measured for the coated substrates according to the invention, before and after heat treatment, are summarized in the table below:
L*R, a*R and b*R indicate the colors in reflection L*, a* and b* in the L*a*b* system measured according to the D65 illuminant at 2° , observer on the side of the stack and thus measured perpendicularly to the glazing;
LR indicates: the light reflection in the visible region in %, measured according to D65 illuminant at 2° , observer on the side of the stack;
L*T, a*T and b*T indicate the colors in transmission L*, a* and b* in the L*a*b* system measured according to the D65 illuminant at 2° Observer and thus measured perpendicularly to the glazing;
LT indicates: the light transmission in the visible region in %, measured according to the D65 illuminant at 2° Observer;
Abs. indicates: the light absorption in the visible region in %, measured according to the D65 illuminant at 10° Observer;
Rsq indicates the sheet resistance.

| | Color in reflection | | | Color in transmission | | | Factors % | | | Rsq |
|---|---|---|---|---|---|---|---|---|---|---|
| | L*R | a*R | b*R | L*T | a*T | b*T | LR | LT | Abs | — |
| Before HT | 23.7 | −0.83 | −9.05 | 92.81 | −1.9 | −0.48 | 4.01 | 82.53 | 13.46 | 9.43 |
| After HT | 23.9 | −0.85 | −8.91 | 92.7 | −2.06 | −0.65 | 4.08 | 82.22 | 13.71 | 9.36 |
| Variation | ΔL*R | Δa*R | Δb*R | ΔL*T | Δa*T | Δb*T | ΔLR | ΔLT | ΔAbs | ΔRsq |
| | 0.2 | −0.02 | 0.14 | −0.11 | 0.16 | 0.17 | 0.07 | 0.31 | −0.25 | −0.07 |

| | |
|---|---|
| ΔE | 0.26 |

After heat treatment, the visual examination of the material according to the invention does not make it possible to perceive the presence of a site of corrosion.

1. A material comprising:
a transparent substrate coated with a stack of thin layers comprising at least one silver-based functional metal layer, wherein the stack comprises:
a dielectric layer based on silicon and/or aluminum nitride located above a silver-based functional metal layer, and
an upper protective layer based on zirconium titanium oxide located above the dielectric layer based on silicon and/or aluminum nitride and exhibiting a ratio by weight of titanium to zirconium Ti/Zr of between 60/40 and 90/10.

2. The material as claimed in claim 1, characterized in that wherein the upper protective layer has a thickness:
of less than or equal to 5 nm, and/or
of greater than or equal to 2 nm.

3. The material as claimed in claim 1, characterized in wherein the dielectric layer based on silicon and/or aluminum nitride has a thickness:
of less than or equal to 50 nm, and/or
of greater than or equal to 20 nm.

4. The material as claimed in claim 1, wherein the dielectric layer based on silicon and/or aluminum nitride is in contact with the upper protective layer based on zirconium titanium oxide.

5. The material as claimed in claim 1, wherein the ratio by weight of titanium to zirconium Ti/Zr is between 60/40 and 70/30.

6. The material as claimed in claim 1, wherein the stack of thin layers comprises at least one silver-based functional metal layer and at least two dielectric coatings, each dielectric coating comprising at least one dielectric layer, so that each functional metal layer is positioned between two dielectric coatings.

7. The material as claimed in claim 1, wherein the stack comprises at least one blocking layer located below and in contact with a silver-based functional metal layer.

8. The material as claimed in claim 1, wherein the stack comprises at least one blocking layer located above and in contact with a silver-based functional metal layer.

9. The material as claimed in claim 7, wherein the blocking layers are based on a metal chosen from niobium Nb, tantalum Ta, titanium Ti, chromium Cr or nickel Ni or based on an alloy obtained from at least two of these metals.

10. The material as claimed in claim 1, wherein the stack comprises:
a dielectric coating located below the silver-based functional metal layer,
a first blocking layer,
the silver-based functional metal layer,
a second blocking layer,
the dielectric layer located above the silver-based functional metal layer,
an upper protective layer.

11. The material as claimed in claim 1, wherein the stack comprises:
a dielectric coating located below the silver-based functional metal layer comprising at least one dielectric layer based on silicon and/or aluminum nitride,
a first blocking layer,
the silver-based functional metal layer,
a second blocking layer,
the dielectric coating located above the silver-based functional metal layer comprising at least one dielectric layer based on silicon and/or aluminum nitride,
an upper protective layer.

12. The material as claimed in claim 1, wherein the substrate is made of glass.

13. The material as claimed in claim 1, wherein at least the substrate coated with the stack is bent and/or tempered.

14. A process for obtaining a material comprising a transparent substrate coated with a stack of thin layers deposited by cathode sputtering, optionally assisted by magnetic field; the process comprising the sequence of following stages:
depositing at least one silver-based functional metal layer on the transparent substrate, then
depositing at least one dielectric layer based on silicon and/or aluminum nitride above the silver-based functional metal layer,
depositing an upper protective layer based on zirconium titanium oxide, exhibiting a ratio by weight of titanium to zirconium Ti/Zr of between 60/40 and 90/10, above the dielectric layer based on silicon and/or aluminum nitride.

15. The process as claimed in claim 14, further comprising subjecting the substrate coated with the stack of thin layers to a heat treatment at a temperature of greater than 400° C.

16. The material as claimed in claim 8, wherein the blocking layers are based on a metal chosen from niobium Nb, tantalum Ta, titanium Ti, chromium Cr or nickel Ni or based on an alloy obtained from at least two of these metals.

17. The material as claimed in claim 1, wherein the stack comprises:
a dielectric coating located below the silver-based functional metal layer,
the silver-based functional metal layer,
the dielectric layer located above the silver-based functional metal layer,
an upper protective layer.

18. The material as claimed claim 1, wherein the stack comprises:
a dielectric coating located below the silver-based functional metal layer comprising at least one dielectric layer based on silicon and/or aluminum nitride,
the silver-based functional metal layer,
the dielectric coating located above the silver-based functional metal layer comprising at least one dielectric layer based on silicon and/or aluminum nitride,
an upper protective layer.

19. The material as claimed in claim 12, wherein the glass is soda-lime-silica glass.
